(19) United States
(12) Patent Application Publication
(10) Pub. No.: US 2024/0247382 A1
(43) Pub. Date: Jul. 25, 2024

(54) Surrogate Electrolyzers Producing Hydrogen and an Arbitrage of Urea, Formamide, Ammonia and Methanol

(71) Applicant: Christopher Papile, Morgantown, WV (US)

(72) Inventor: Christopher Papile, Morgantown, WV (US)

(21) Appl. No.: 18/413,695

(22) Filed: Jan. 16, 2024

Related U.S. Application Data
(60) Provisional application No. 63/439,260, filed on Jan. 16, 2023.

(51) Int. Cl. C25B 1/50; C25B 1/27; C25B 9/23; C25B 13/07

(52) U.S. Cl. CPC C25B 1/50; C25B 1/27; C25B 9/23; C25B 13/07

(57) ABSTRACT

The equipment, methods, and materials of electrochemical processes undergoing a series of hydration, dehydrogenation and OER processes are used to produce electrochemical hydrogen and a second product, or ammonia and methanol, or methanol alone, or methanol and urea, or formamide and D.I. water. The processes allow for flexibility of products to insure good profitability into the future of unknown pricing premiums for H₂, NH₃, CH₃OH, H₂NCH═O or (NH₂)₂C═O. All the processes herein, including the production of ammonia and urea, do not cause net nitrification of soil and water and are CO₂-free.

### FIELD

The subject matter disclosed herein relates to the production of CO₂-neutral or negative hydrogen, methanol, ammonia, D.I. water, reduced iron, formamide and urea, which are important fuels, chemicals, materials and fertilizers.

### BACKGROUND

The ammonia process, which is important for fertilizers and chemicals, has had small changes since Haber's work over a century ago. Improvements in reforming to produce hydrogen have been made over the last decades, but recently, sustainability concerns have brought about new ammonia production approaches, centered around using water electrolysis to feed hydrogen.

Water electrolysis, reforming and e-SMR, have several practical issues in the production of ammonia or dual ammonia-methanol processes. Chiefly the high reliance on electrical input does not fit well with dynamic, unreliable renewable electricity resources. Further the production of methanol from natural gas, or CO or CO₂ is limited by the hydrogenation step thermodynamics

The current process, described herein, for the production of hydrogen, ammonia, urea, methanol and formamide well buffers the effect of dynamic electrical input, and solves the issues with methane to methanol. The current process does not emit CO₂ and does not cause net nitrification of soil and water, does not require precious water input to make formamide and urea; therefore, a new sustainable process to make ammonia and its related molecules is now described.

### BRIEF DESCRIPTION OF FIGURES

FIG. 1 is a process flow diagram for a surrogate electrolyzer, in which a propylene, IPA, acetone cycle is used to produce oxygen and hydrogen. The O₂ and H₂ may be produced non-simultaneously.

FIG. 2 is a process flow diagram of a surrogate electrolyzer split into three components, high temperature ceramic solid oxide membrane electrochemical deoxygenation (Unit 201) of isocyanic acid, low temperature hydration of HCN, and mid-temperature dehydrogenation of formamide.

FIG. 3 is a more detailed process flow diagram of formamide reaction to hydrogen and isocyanic acid that is the feed to a distillation reactor reacting methane and producing methanol and remaking formamide. One net mole of water and one net mole of methane are consumed to make one net mole of H₂ and one of methanol.

FIG. 4. is a process flow diagram showing a dehydrogenation (401) reactor, a methanol production reactor (402) and a HCN hydration reactor (406). Here a heterogenous catalyst causes the production of condensed methanol (in 402), which absorbs onto a polar material, separating CH₃OH from unreacted isocyanic acid to drive the reaction forward, increase equilibrium production of methanol and halting further oxidation of produced methanol.

FIG. 5 is a process flow diagram in which a SOFC is used in a ceramic membrane ammoxidation reaction to produce HCN (in anode 502) that is then hydrated (Unit 504) to formamide and hydrogenated to methanol and ammonia.

FIG. 6 is a ceramic proton-conducting membrane reactor (Fuel Cell with anode 601 and cathode 604) in which the anode reacts ammonia and methane, protons transverse the ceramic membrane and the cathode may oxidize the ceramic membrane-transversed protons using nitrogen oxides (preferably from waste remediated) or oxidize with O₂ in the cathode 604.

FIG. 7 is a similar process flow diagram to FIG. 6, but instead of hydrogenating formamide directly, formamide is transamidated to release ammonia for recycle and the new amide is then hydrogenated to methanol.

FIG. 8 is a process similar to the FIG. 7 process, but this process of FIG. 8 has an optional pathway to produce urea from formamide and ammonia at unit 804 and 805.

FIG. 9 is a diagram of the process flow for the transamidation of formamide, prior to hydrogenation of the new amide to methanol. The transamidation added step assists in separation since ammonia is more simply separated from high molecular weight amides and methanol is more easily separated from high molecular weight amines.

FIG. 10 is a similar process flow diagram of the transamidation, ammonia separation, hydrogenation and stripping of methanol from piperidine, the recycle of piperidine and the purification of methanol to industrial grade methanol. Typical pressure and temperature conditions are provided.

FIG. 11 is a simplified process flow diagram showing the ceramic membrane reactor (CMR) or alternatively named eARM fuel cell, in which methane with ammonia is converted to HCN, then hydrated to formamide (symbolically shown in the reaction box) then hydrogenated by electrolysis (ELY) hydrogen, which was powered by the CMR fuel cell reaction current and heat to power, splitting formamide into methanol and ammonia, such that methanol is an output of the process and ammonia is separated from the methanol and returned to the inlet of the CMR with fresh methane.

FIG. 12 is the process flow diagram for the dissolution of raw iron ore with nitric acid, followed by the conversion of resulting nitrogen oxides to ammonia and CO. The carbon dioxide is used to reduce iron complexes generated by the irone ore dissolution.

### DETAILED SPECIFICATION

The Andrussow and BMA processes feed methane, ammonia and optionally oxygen to produce HCN and either water or hydrogen. In contrast to these processes, described herein, the temperature of operation can be reduced, electric power may be generated, formamide may be produced with hydrogen, if a ceramic membrane fuel cell is used and coupled with a lower temperature hydration reaction.

The present invention may feed HNO₂ and/or NO₂ and/or NO on one side of a ceramic proton-conducting membrane reactor (usually the cathode) and feed methane and ammonia on the other side of the proton-conducting ceramic membrane reactor (anode) to simultaneously produce ammonia without air separation. This allows for no net nitrification of soil and waterways in the production of ammonia or urea or formamide, in an overall process that does not have CO₂ emissions, may not require water to produce urea or formamide and has an economically beneficial arbitrage of products.

It has been shown by other investigators that plasma reactions can decrease the temperature of HCN production to 400° C.[Dalian, 2021]. While the current results herein use ceramic membrane reactors to convert the old HCN-process to a new versatile process for coproducing at practical temperature: hydrogen and formamide, or D.I water and formamide, or methanol and ammonia, or methanol only, or urea and D.I. water and methanol, or reduced iron Fe(0) and urea. The facile hydrogenation of formamide and amides is detailed herein and is a better method to produce methanol as compared with other starting points, such as NG reforming, CO or CO₂.

Further, a related new type of electrolyzer is described, herein. The new electrolyzer decouples the OER and HER reactions, such that, when renewable electricity is not available, the reactions that produce H₂ from water continue.

Surrogate electrolyzer indicates the OER O₂ and the HER H₂ are produced not directly from H₂O, but from an hydrated carrier molecule. This electrolysis system is economically preferred, since it decouples the OER and HER in space, time, temperature and pressure to optimize conditions for each reaction, optimize 24/7 performance and overall economics. The new electrolyzer may produce hydrogen even when microgrid renewable electricity is down and renewable electricity cost is low.

Using similar techniques, the process and materials described herein, produce methanol from methane. The current process is simpler than natural gas reforming plus CO hydrogenation process. Formamide is hydrogenated to methanol and ammonia and the ammonia may be recycled back to the ceramic membrane ammoxidation process.

Or ammonia is made simultaneously with methanol. The process uses a ceramic membrane reactor. In the preferred configuration the ceramic membrane reactor is proton conducting. If the cathode of the ceramic proton-conducting membrane oxidizes with NOx instead of O₂ then ammonia is produced in the cathode. The ammonia production does not use air separation, rather it may use waste nitrates.

Urea is made using dehydrogenative coupling between formamide and ammonia fitting seamlessly into an economically beneficial arbitrage of products. If Formamide is the main product then D.I. water may be coproduced for enhanced economics.

Water electrolysis is potentially an important tool in the reduction of CO₂ associated with fuels. Electrolyzers suffer from a large electrical energy requirement, translating to a large OPEX in industrial installations. When producing hydrogen and oxygen from water, the Gibbs energy of formation is 237.1 to 228.6 KJ/Mol (liquid water or steam at standard state, respectively) defining an unavoidable energy penalty. Another issue with water electrolyzers is they may be fed electricity from renewable microgrids but the renewable electricity source is not available 24/7. Yet further concerns have to do with the need of water that is extremely clean.

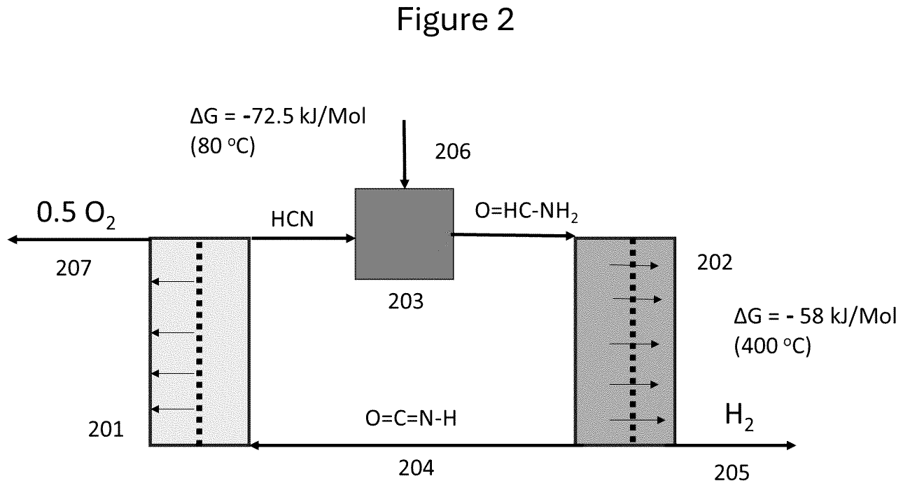

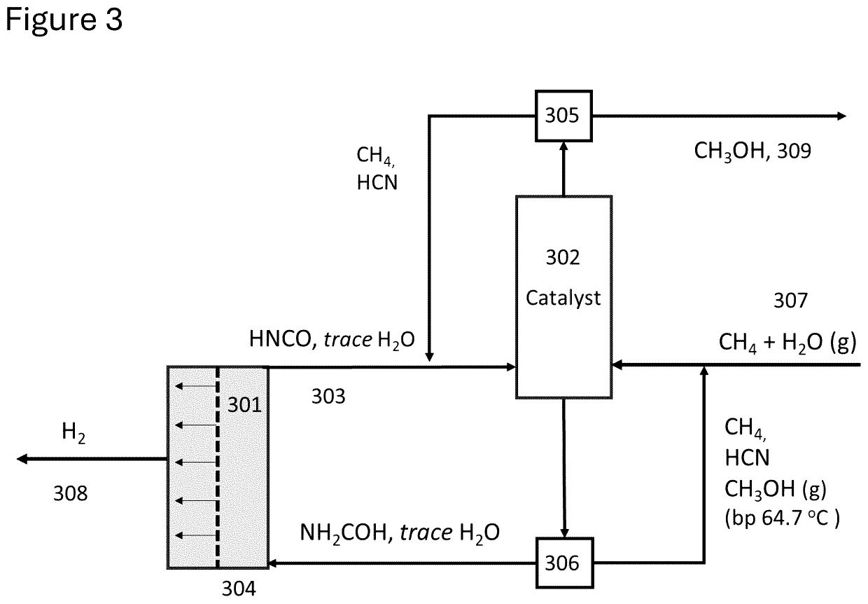

Ways to reduce the OPEX limitation include to produce a different, useful product, in place of O₂, which requires lower overall electrical input. FIGS. 2 and 3 show process flow diagrams for CH₃OH production instead of O₂. Another way to improve around the limitation is to modify/optimize the pressure and temperature of parts of the system separately (for example, using energy brought by heat to decrease the burden on the electrical input). Another improvement is to make H₂ 24/7 thus maximizing the CAPEX payback time period even though electricity is not available 24/7. The current surrogate electrolyzer enables these features and more.

Surrogate electrolyzers use a working fluid to accomplish OER and HER. The requirement of the working fluid is that it can be hydrated (add water), then dehydrogenated (release H₂), then deoxygenated (remove 0.5 O₂) in a continual cycle, in which the reaction to hydrate and dehydrogenate are Gibbs Energy favorable and preferably the hydration+dehydrogenation are together exothermic.

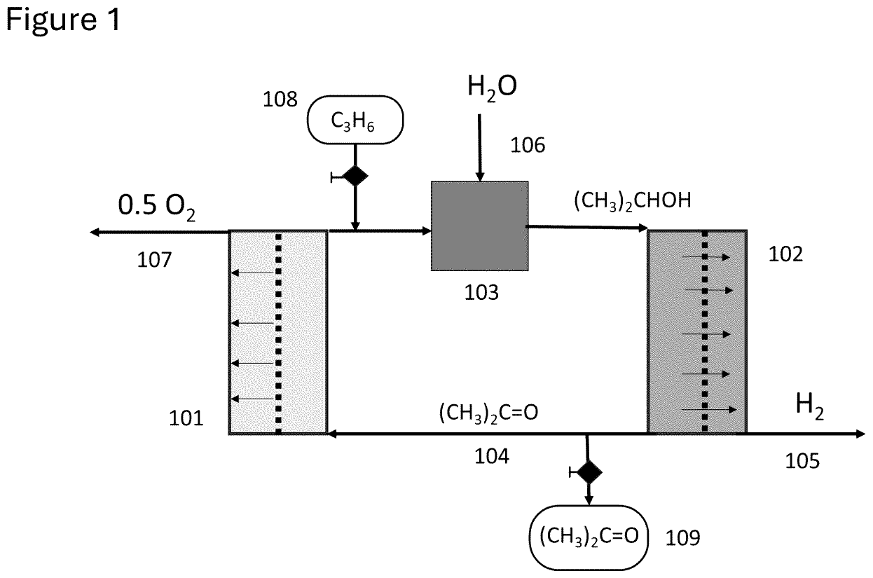

FIG. 2 shows a flow diagram for a surrogate electrolyser cycle using isocyanic acid and formamide. Examples are provided of the nitrogen containing cycle, since it fits with the later part of this innovation (isocyanic acid is a Wohler feedstock to urea). FIG. 1 shows the process flow diagram of another example: (1) green propylene, (2) hydrate to isopropyl alcohol (IPA), (3) dehydrate to acetone, (4a) sell acetone and hydrogen or (4b) deoxygenate acetone back to isopropylene.

Isopropylene may be stored such that if green electricity is not available, the stored propylene can be hydrated, then IPA dehydrogenated and stored as acetone, until electricity is again available. This takes care of the problem of non-24/7 renewable electricity. In this case the hydration reaction of propene to IPA is exothermic and the hydration reaction Gibbs Energy favorable, below 375 K, and the dehydrogenation of IPA to Acetone becomes Gibbs favorable above 500 K.

FIG. 1 diagram shows propene storage in 108, propene hydration at 103, IPA dehydrogenation (either electrochemical or membrane pressure driven), Acetone storage at 109, Acetone deoxygenation in reactor 101, producing O₂ at outlet 107 and H₂ at outlet 105. The surrogate electrolysis of FIG. 1 decouples the production of O₂ and H₂ and only requires renewable electricity for the production of O₂.

One may expect some reduction in electrical power cost, since the hydrogen generating reaction can be operated at a lower temperature and in theory does not require electrochemical electricity, while the acetone deoxygenation is driven electrically at O²⁻-conducting membrane temperatures. The deoxygenation reaction can be operated during low electricity cost time-periods in the day, as well.

Industrial motivations to use a surrogate electrolysis material is (1) less vulnerability to impurities in the water, (2) less vulnerability to electrical down-time, (3) ability to separately optimize the conditions (T and P) for hydrogen and oxygen evolution reactions, (4) increased profitability in sale of side produce, (5) generally decoupling the HER and OER reactions. The process is less sensitive to water impurities, since the water if fed to a hydration reactor and not to a sensitive, expensive electrode catalyst. The hydration reactor catalyst is less expensive and easier to replace than electrode catalyst refurbishing.

FIG. 2 is a process flow diagram of a new electrolyzer in which isocyanic acid is stripped of oxygen in a solid oxide membrane reactor (201), then the produced HCN is hydrated (203) to formamide, and finally, to complete the cycle, formamide is dehydrogenated (202) to isocyanic acid and H₂.

The O²⁻-conducting membrane reactor of 201 is operated at >600° C. and the proton-conducting membrane reactor (202) is operated at various temperatures depending, if the equipment configuration uses PEM membrane or a proton-conducting ceramic membrane or no membrane nor electrochemistry. The dehydrogenation reactor thermodynamics are favorable at 400° C. The process to strip-out H₂ can be driven by electric current or simply be temperature and pressure-driven, since the Gibbs energy of the reaction is favorable, −58 KJ/mol at 400° C.

This electrolyzer configuration allows for the operation at three different temperatures within the electrolyzer system to optimize thermodynamic and kinetic conditions for OER, HER and hydration. For example, the reaction of gas phase HCN and liquid water to produce liquid formamide avoids the input of water and formamide heat of vaporization. With the proper catalyst the dehydrogenation reaction of 202 may be optimized to utilize liquid formamide (FAM) thus avoiding FAM heat of vaporization. In which an electrolyzer system at three temperatures brings a theoretical reduction in the electrical input per gram of hydrogen by >10%.

Other advantages include that water quality hiccups may be withstood since it is inputted at HCN hydration reactor and not directly into a delicate electrolyzer. In this way the level of deionization is more able to absorb deviations from recommendation, since the water does not come in contact with the delicate electrodes. Another advantage is following load may be more facile, since only the solid oxide membrane O₂ rejection requires electricity in the electrolyzer system; thus, to withstand electricity input drops/dynamics, simply a reservoir of extra HCN may be available in the electrolyzer system, to continue to produce H₂ through reactor 203 and reactor 202 of FIG. 2.

The configuration of FIG. 2 lends itself to modification to incorporate methane-assisted electrolysis to produce methanol and hydrogen instead of 0.5 O₂ and hydrogen. The equipment uses HNCO (isocyanic acid) to oxidize methane in analogy to proven, N₂O oxidation of methane. The activation of methane is often either kinetically slow with low methanol conversion or sufficiently fast but low yield due to over-oxidation producing CO₂. The over-oxidation challenge, reducing yield, is a problem that is reduced by the use of HNCO instead of O₂ or N₂O.

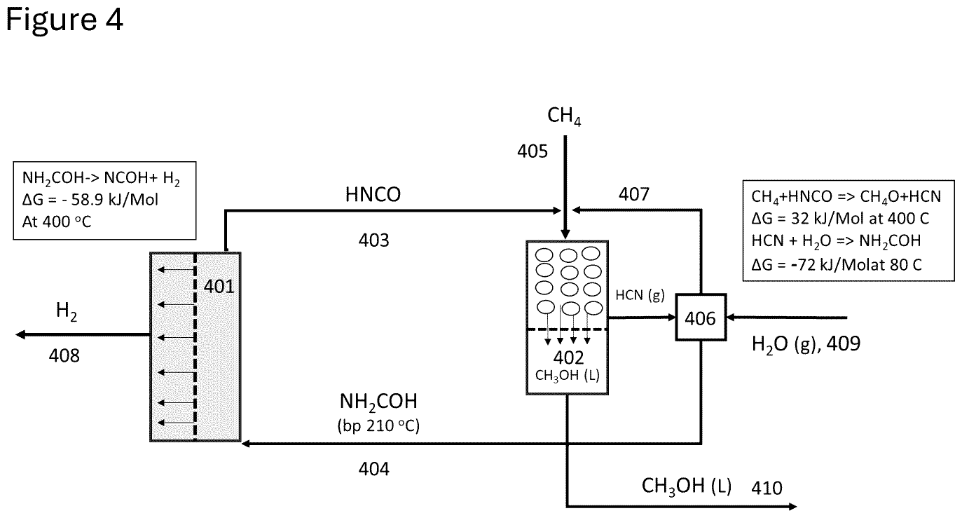

FIGS. 3 and 4 indicate electrolysis with coproduction of methanol. Reactor 302 of FIG. 3 may be a reactive-distillation system (combining the methanol and formamide making reactions). In said distillation reactor gasses are added, at 303, near the bottom of the column, while produced formamide gravity drops to the reboiler and methanol produced leaves at the top at the condenser, 305. The condenser is used to separate unreacted HCN and methane from methanol product. The reboiler, 306, is used to separate product formamide and unreacted (if any) HCN, CH₄ and methanol. Formamide is dehydrogenated in reactor 301 (and oxygen leaves the system in CH₃OH). Reactor 301 may be a proton-conducting ceramic membrane or a PEM membrane electrolysis or simply a plug flow reactor with an associated separation unit (to separate H₂ and HNCO). In the case of the dehydrogenation of formamide to HNCO, the reaction is Gibbs favorable and exothermic, so no electrochemical components to drive the H₂ through the membrane are needed. Therefore the amount of electrical energy used for this system is minimal, since the reaction to dehydrogenate formamide to isocyanic acid and hydrogen is Gibbs energy favorable at 400° C.

Potentially no electric power is needed to cause the dehydrogenation reaction to good equilibrium conversion. However, the continual separation of hydrogen away from HNCO is beneficial; therefore the use of a PEM membrane or a proton-conducting ceramic membrane or a pressure-driven palladium membrane or a pressure-driven zeolite membrane will bring dehydrogenation yield towards 100% in one pass. The dotted line in reactor 301 of FIG. 3 may represent any of these aforementioned types of membranes. The reaction is thermodynamically favorable and can be operated at 400±100° C.

Various materials operate as dehydrogenation catalysts in Reactor 102, 202, 301 and 401. Catalytic materials include <1% Platinum on gamma-alumina, Platinum-Tin on Mg—Al—O, Pt/Mo/SlO₂, Platinum on supports USY zeolite, TiO₂, TiO₂/Al₂O₃, Ce—Mg—Al—O, Palladium, Ruthenium, Chromium Oxide, Vanadium Oxide, Gallium oxide, Iridium, Cooper, Molybdenum, Iron, Bimetallics: Ni—Ag, Ni—Zn, Ni—Sn, Fe—Mo—S.

For processes shown in FIGS. 3 and 4 reactors 302 and 402 undergo the oxidation of methane to produce methanol in analogy to the reaction of nitrous oxide with methane to make methanol. N₂O reaction with methane is shown in Eq. 3 and 4. N₂O can over oxidize methanol in a thermodynamically facile reaction to undesired CO₂. The oxidation of methane with isocyanic acid is tempered as shown in Eq. 6, since the ΔG is much less than that of the full oxidation of methane with N₂O.

TABLE 1

| | | |
|---|---|---|
| CH₄ + HNCO => CH₃OH (L) + HCN | Eq. 1 | |
| HCN + H₂O => NH₂COH (L) | Eq. 2 | |
| N≡N⁺—O⁻ ⇔ N⁻═N⁺═O + CH4 → CH₃OH + N₂ | Eq. 3 | Happens but low yield −220 |
| BP −88.48 | | kJ/Mol |
| 4 N₂O + CH₄ => CO₂ + 2 H₂O + 4 N₂ | Eq. 4 | Difficult to stop, highly |
| | | favorable −1,216 kJ/Mol |
| H—N═C═O + H₂O → CO₂ + NH₃ | Eq. 5 | Avoid by dry and no catalyst |
| BP 23.5 | | |
| 4 HNCO + CH₄ => CO₂ + 2 H₂O + 4 HCN | Eq. 6 | Decreased full-oxidation driver |
| | | as N₂O −539 kJ/Mol |
| H₂NCH═O → CO + NH₃ | Eq. 7 | Avoid by pressurization |
| H₂NCH═O → H—N═C═O + H₂ | Eq. 8 | Membrane-Catalyst |
| 2 H—N═C═O → CO + H₂N₂CO | Eq. 9 | Not observed [Hue University |
| | | Journal of Science: Natural |
| | | Science; ISSN 1859-1388] |
| CH4 + NH₃ + O₂ → HCN + 3 H₂O | Eq. 10 | |
| 2 NO + 2 CH₄ → (NH₂)₂CO + CH₃OH | Eq. 11 | No electrolyzer required. All |
| | | hydrogen from methane. |
| CO₂ + 3 H₂ → CH₃OH + H₂O | Eq. 12 | Competitive approach |
| CO + 2H₂ → CH₃OH | Eq. 13 | Industrial process hydrogen need |
| | | to produce methanol |

Reaction #2 is facile, having a favorable ΔG=−83.6 KJ/mol at room temperature. Reaction #1 is less favorable but can be driven by Le Chatelier's principle by continual making-removing liquid methanol.

Suitable two-phase reactors also include a CSTR bubble homogeneous reactor or capillary continual liquid removal reactor or a pressure-drive membrane reactor. A capillary material may be conducive to high polarity liquid selective movement. A capillary may be used to draw away condensed polar formamide and methanol from unreacted HNCO, CH₄ and HCN which are recycled to the start of said two-phase reactor.

FIG. 4 shows the formamide dehydrogenation reactor paired with a capillary run-off reactor in which produced methanol condenses is drawn through a polar material, to keep the concentration of liquid products low compared to the gas-phase reactants at the catalyst interface shown as circles in FIG. 4 reactor 402. The double dotted lines in the reactor 402 indicate a material that absorbs polar methanol liquid, but does not let gases (methane, HNCO, HCN) pass through.

### Methanol by Ceramic Membrane Reactors

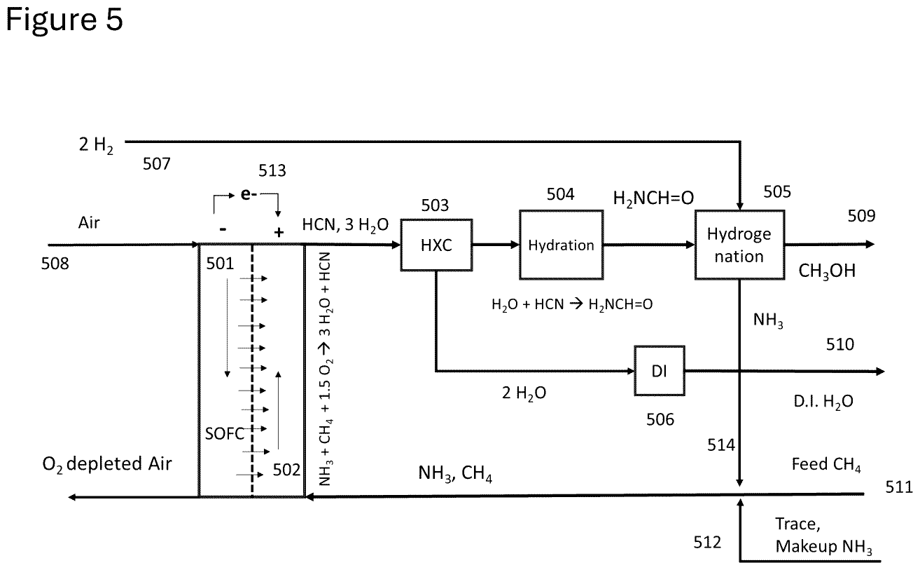

FIG. 5 is a process flow diagram (PFD) showing a method and equipment with materials to produce methanol from methane facilitated by ammonia internal recycle (see 514) using a ceramic membrane fuel cell. To produce methanol in this process, the ammonia is not consumed, rather it facilitates the production of HCN, for example the NH₃ stops carbon growth on the anode of the SOFC shown in FIG. 5.

Equipment Cathode 501 and Anode 502 are part of a is a solid oxide fuel cell type reactor. Air is input at 508 and oxygen transverses a O²⁻ membrane. An example ceramic membrane is Yittria-Stabilized Zirconia (YSZ) or <50 μM BZY or Al₂O₃ doped YSZ or ScSZ and CeO₂—Y₂O₃/SrO₂ or BaZr_{0.1}Ce_{0.7}Y_{0.2}O_{3-d} or Lanthanum strontium manganite (LSM/YSZ), Zirconia (fluorite structure) doped with CaO, MgO, Y₂O₃, SC₂O₃, Sm₂O₃ and Yb₂O₃, LaGaO₃ (at <800 C) generally MIECs. The ceramic membrane transversing O²⁻ reacts with H₂ that is stripped off methane and ammonia as they produce HCN.

Suitable cathode materials include: LSCrMn and LaCo₃ doped with SrO₂ and LaSrCoMnO₃ and La_{0.5}Sr_{0.5}MnO_{3-δ}.

The SOFC may generate electricity. The reaction to make HCN, Equation 10, is ΔH=−474 KJ/Mol exothermic and generates ample ΔG=−526 KJ/mol used to produce power in a SOFC configuration. The SOFC reaction forms 3 internal waters, which is the power driver (ΔG=−685.8 KJ/3-moles H₂O at standard state). The process of FIG. 5 shows at input 507 requires 2 moles of hydrogen to hydrogenate formamide (FAM) to make methanol and ammonia. Table 3 shows that at 1100 K, if instead of a SOFC a ceramic proton-conducting membrane reactor (PCFC) is used, net H₂ may be produced and overall power generation from the PCFC fuel cell.

The power generated from the SOFC in theory is sufficient to drive electrolyzers to make hydrogen by onsite electrolysis for hydrogenating formamide as shown in FIG. 5 at Unit 505. When taking practical Ohmic and other losses into account at 65% efficient SOFC and a 95% efficient water SOEC electrolyzer the process will still avoid external electrical power to drive the electrolyzer (at 507 of FIG. 5) process hydrogen.

At less than 65% efficient SOFC in FIG. 5 then waste heat is generated. The waste heat can be converted to electricity and put together with the power generated from the SOFC of FIG. 5 to produce sufficient power to produce 2 moles of hydrogen at 507 per mole of methanol outlet 509.

1 mole of methanol from 1 mole of methane and air may be produced by a combined external electrolyzer and the SOFC ammoxidation reaction (NH₃, CH₄ and membrane-fed O₂). Some electrical input may be needed to operate compressors, but the overall electric power requirement of the process and simplicity of the current process (methanol from methane shown in FIG. 5) is superior in energy usage (lower OPEX/mole-CH₃OH) to other industrial processes that make methanol from natural gas or CO₂ or CO.

The current process would enable methane from anaerobic biodigestors to produce methanol from methane onsite, since unlike methane reforming, this new SOFC process to make methanol may be operate at small-scale without loss of economy of scale advantages.

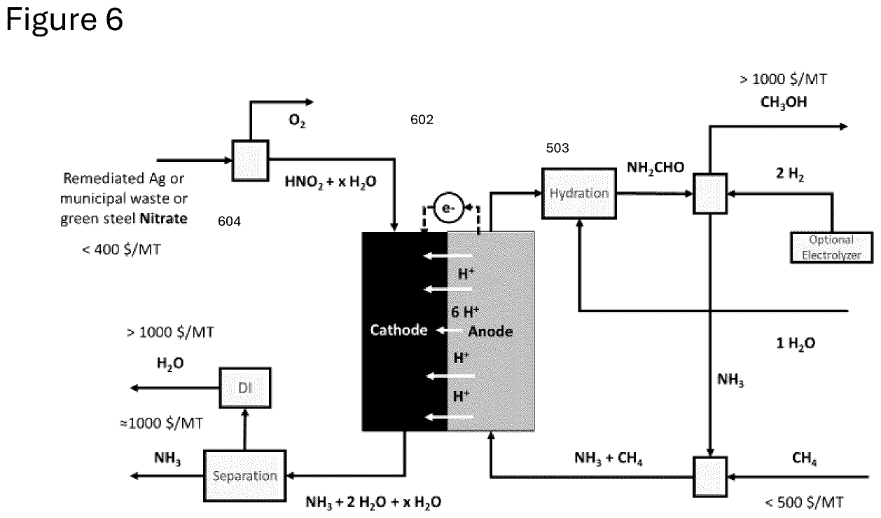

The reaction to make HCN from NH₃ and CH₄ is >60% conversion at and 825° C. in an SOFC and even higher conversion at higher temperatures. In the next section, the process using a proton-conducting membrane fuel cell is described. Using a proton-conducting membrane Fuel Cell higher pressure also increases conversion of methane to desired products (FIGS. 6, 7 and 8). In the proton conducting membrane reactor, increasing the pressure (up to 35 bar) further improves yield to HCN with less NH₃ unselective reactions.

Suitable catalysts on the anode side of the SOFC of FIG. 5 include platinum, Rhenium, Ag, Au, Nickel and Cu as well as Y, La and Ir, supported on various supports including AlN, Si₃N₄, SiC and Ni—ZrO₂-Cermet and platinum-Zirconia cermet and platinum-nickel-zirconia cermet. Or platinum catalysts. The rate and conversion of methane and ammonia to HCN is fastest with highest conversion at excess ammonia.

The process of the SOFC to produce HCN has some unselective NH₃ conversion to small amounts N₂ or NO and some loss of methane to small amounts of CO and CO₂. Trace makeup ammonia may be added to the process shown in 512. And/or hydrogenation of unselectively produced NO back to NH₃ in reactor 505 maintains the NH₃ internal recycle at sufficient levels throughout the life of the process operation. Hydrogenation reactor 505 of FIG. 5 hydrogenates formamide to ammonia (and methanol) and NO to NH₃.

In FIG. 5, the reaction of the anode (502) in the SOFC may be operated at 825° C. or other suitable temperature depending on which ceramic O2⁻-conducting material is utilized.

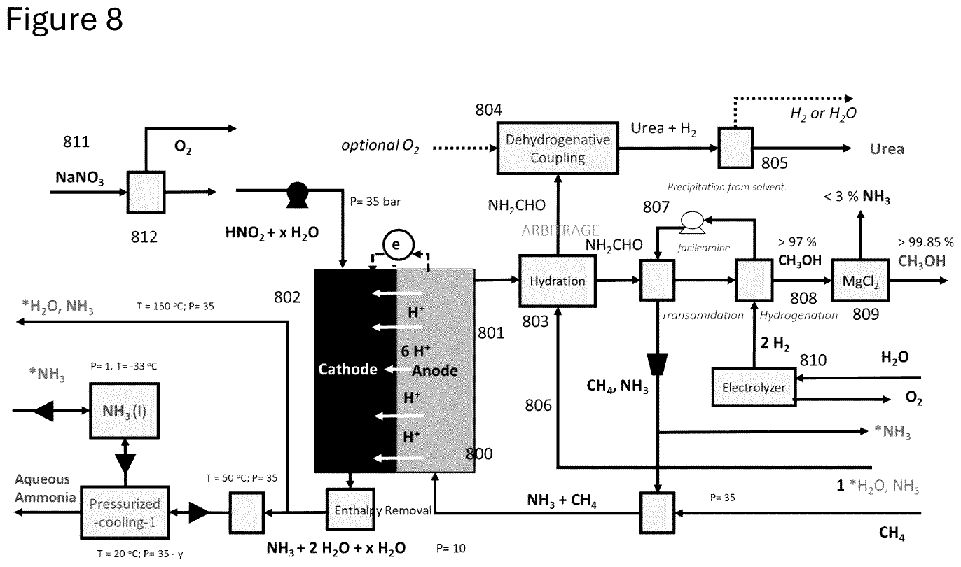

SOFC with Anode 502 and Cathode 501 produces electricity at 513 and product HCN plus water. Condenser, heat exchanger 503 separates out some of the produced water, which is cleaned of any soluble HCN and may be sold as industrial DI water or used in onsite electrolyzers. The process may have three products, DI water, methanol and formamide. The process of FIG. 8 when producing urea may make net excess water or hydrogen as shown in Unit 805 of FIG. 8 and Table 6 equation:

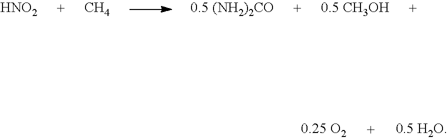

If the methane fed to the process depicted in the process flow diagram (PFD) of FIG. 5 originates as RNG, then the methanol produced is decarbonized, green methanol.

The process is fed from 504 to unit 505 and contains water with HCN and trace NO. Unit 503 is used to reduce temperature for feed to a hydration reactor 504. Catalysts used in reactor 504 include, used separately or together: Amberlyst 35 at 100 C, Chlorinated polyvinylbenzene based acidic resins, Ferrierite at >150 C, Cu and Ca montmorillonites at <200 C, TiO₂>200 C and Fe and/or Cu ZSM-5 at >225 C, Nb/La—TiOₓ at 97% at 250° C., Ni/TiOx at 300° C., Fe/TiOx at 300° ° C., 90% yield, Nb-ZSM-5 at 250° C., 85% yield and Al₂O₃ 400° C.

The hydration of HCN to formamide is more favorable at below 230° C., whereas the membrane-based ammoxidation reaction to make HCN is best operated between 650 to 1000° C. HCN is favorably hydrated to formamide, which itself is a sellable product. Hydrogenation of formamide and trace NO in 505 produces methanol and ammonia. Methanol and ammonia are separated in 505. Ammonia is recycled back to the SOFC with fresh methane. The process diagramed in FIG. 5 has all the advantages of direct methane to methanol processes. The process of FIG. 5 may require a source (such as an electrolyzer) of hydrogen, if methanol is the desired product.

If a ceramic proton-conducting membrane reactor is used in place of the SOFC, as shown in FIGS. 6, 7 and 8, then as shown in Table 3 Equation 14, the overall system may have no hydrogen deficit. It is a de facto direct methane to methanol process.

The process of FIG. 5 may be further embellished at 505 to undergo formamide transamidation, such that the products (a new amide and ammonia) are separated and ammonia is sent to recycle, while the new amide is hydrogenated to methanol. The transamidation reaction requires a new carrier amine to take the place of ammonia in formamide. The carrier amine is recycled back to the transamidation reactor after the transmamide is hydrogenated to methanol and said carrier amine.

Transamidation catalysts include Boronic Acid and can reach 99% conversion of formamide to formylbenzlamine. Carrier or facile amines for transamidation include Carbazole, Piperidine, Aniline, Pyrrole to make amides such as, formylpiperidine, which can be hydrogenated to methanol and recycle piperidine. The Nitrogen in Carbazole may be changed to P, As, Sb, or related Se and Te versions of carbazole. The transamidation reaction may be catalyzed by B(OH)₃, boronic acid or forms of boronic acid such as dichlorophenylboronic acid.

The DI water produced in 506 from the excess water of condenser 503 may be partially used as feed to electrolyzers at 507 to produce hydrogen for formamide splitting into methanol and ammonia. If formamide is the product of the process (instead of methanol) of FIG. 5 then net DI water coproduction at Units 506 and 510 can be sold together with formamide.

The Cathode (501) of SOFC of FIG. 5 may reduce the O²⁻ flow to the anode, in order to not consume all the H₂ made in the anode. In this way the process of FIG. 5 may not require external electrolyzers since the HCN production reaction may produce approximately 1 mole H₂O and 2 moles H₂ in the anode and still be ΔG favorable. In the case that formamide is the desired product and the SOFC has a limited H₂ oxidation (1 mole H₂O keeping 2 moles H₂), then onsite electrolyzers may not be required in the process of FIG. 5 and hydrogen may be a coproduct with formamide.

The current process is similar to direct methane oxidation to methanol, but the current process consists of a membrane-ammoxidation followed by a hydration followed by hydrogenation. Unlike direct methane to methanol R&D over the past decades, the current new process may achieve very high Methanol yield (>97% possible) in the ceramic proton conducting membrane mode of FIGS. 6, 7 and 8 and >95% in SOFC mode.

The current process (see FIG. 5) is simpler than NG reforming followed by CO hydrogenation to methanol and can be operated at smaller scale and lower pressure as compared with reforming. Table 2 shows the thermodynamic comparison of methanol made from formamide, CO and CO₂. Formamide is a more favorable starting point to make methanol at practical temperature (>473 K).

Reforming of methane has known methods, including CPOX, ATR [4 CH₄+O₂+2 H₂O→10 H₂+4 CO (950-1050° C., 30-50 bar)] and dry reforming (CO₂).

The process shown in FIG. 5 produces higher yield in methanol at a given temperature, with both kinetic and thermodynamic equilibrium advantage. Table 2 shows the ΔG for formamide hydrogenation to methanol is highly favored (ΔG=−24 KJ/mol at 473 K) as compared with CO (ΔG=+13 KJ/mol at 473 K) and CO₂ (ΔG=+36 KJ/mol at 473 K) hydrogenation. Reforming natural gas to syn gas to to methanol is less favorable than formamide hydrogenation which is kinetically facile and thermodynamically high conversion at <160° C. This indicates a very strong advantage to make methanol through formamide instead of natural gas, CO or CO₂.

Catalysts to hydrogenate formamide include supported Ru used in series with K₃PO₄; or homogeneous or supported iron catalysts; or homogeneous or supported platinum; or Fe or Mo in zeolites; or supported palladium or homogeneous palladium; or heterogeneous or homogeneous rhodium; or bimetallics such as Ru—Mo or Ru—Fe or Re—Fe.

TABLE 2

| Methanol Production Comparison | ΔG, kJ/Mol | T, K |
|---|---|---|
| CO + 2 H₂ ⇔CH₃OH | −25.4 | 298 |
| | 13 | 473 |
| CO₂ + 3H₂ ⇔ CH₃OH + H₂O | 4.1 | 298 |
| | 36 | 473 |
| NH₂CHO + 2H₂ ⇔ CH₃OH + NH₃ | −38 | 298 |
| | −24 | 473 |

Referring to Table 2, while Formamide has two gas moles (2 H₂) and a liquid mole (Formamide) to make two gas moles (CH₃OH+NH₃); CO reduction has three gas moles (CO+ 2 H₂) to make one gas mole (CH₃OH), and CO₂ has four gas moles to make three. The decrease in gas moles inhibits the entropy change term (−TΔS) for CO and CO₂ and requires them (CO and CO₂ starting point processes) to use increased pressure at reasonable kinetic temperatures (−TAS where ΔS is negative, makes ΔG less favorable decreasing the equilibrium concentration of CH₃OH production by ΔG=−RTIn[K_{eq}]) and high recycle to make methanol. So, the CO and CO₂ starting point must use pressure and are stuck in a conundrum of higher temperature helps kinetics but not their equilibrium product concentrations.

FIG. 6 shows a process flow diagram in which a ceramic proton-conducting membrane Fuel Cell is used instead of an SOFC of FIG. 5. Thermodynamic data at 827° C. as shown in Table 3 (and generally the reaction conditions between 400 to 1000)° ° C., the combined cathode and anode fuel cell theoretical power when using HNO₂ as an oxidant to consume all protons is approximately—352 KJ/Mol-methane, see Table 3.

To avoid onsite electrolyzers (shown in FIG. 6 as “optional electrolyzer”), Table 3 shows at Eq. 14 that 2 net moles of hydrogen may be produced, if a limited approximate 0.333 moles of HNO₂ (per mole of HCN produced) is used to oxidize hydrogen transversing the proton conducting membrane electrochemical reactor, eARM. Generation of some H₂, some NH₃ and some water in the cathode of the eARM reactor is helpful for avoiding onsite electrolyzers. The eARM fuel cell anode looks like an electrolyzer, producing hydrogen from recycled ammonia (and fresh methane) that obtained it's water from an external hydration reactor.

Further if NO (nitric oxide) is used as an oxidant then excess hydrogen may be available from the eARM reactor.

TABLE 3

| | eARM Fuel Cell | | |
|---|---|---|---|
| | (proton-conducting CMR) | | |
| Eq | T (K)= | 1100 | ΔG |

| | | | |
|---|---|---|---|
| | HNO₂ + 3H₂ -->NH₃ + 2 H₂O | −375 | Cathode |
| | CH₄ + NH₃ -->HCN + 3 H₂ | 23 | Anode |
| | Sum | −352 | |
| | 0.666 HNO₂ + 2 H₂ --> 0.666 | −250 | Cathode |
| | NH₃ + 4/3 H₂O | | |
| | CH₄ + NH₃ -->HCN + 3 H₂ | 23 | Anode |
| | Sum | −227 | Power and H₂ Made |
| 14a | 0.333 HNO₂ + H₂ --> 0.333 | −125 | |
| | NH₃ + 0.666 H₂O | | |
| 14 | CH₄ + NH₃ -->HCN + 3 H₂ | 23 | No electrolyzer |
| | | | needed, 2 moles |
| | | | excess H₂ in CMR |
| | Sum | −102 | |

FIG. 6 shows a process flow diagram that makes modifications to the PFD shown in FIG. 5: differing instead of using O₂ on the cathode, HNO₂ and/or NO₂ and/or NO may be used as oxidant and instead of an SOFC, a ceramic proton-conducting fuel cell, called eARM (ammonia reforming of methane with electric power generation and the more general name, CMR, ceramic membrane reactor).

Methane and ammonia is fed to the anode of eARM as shown in FIGS. 6, 7 and 8. Although eARM (a CMR of ceramic proton conducting type) is a fuel cell that may produce power, the anode generates hydrogen, which transverses the proton conducting membrane thus resembling electrolysis of methane+ammonia. The fuel cell anode that looks like part of an electrolysis process obtains H⁺ from ammonia and methane instead of water (usual electrolysis starting point). Instead water is added to the surrogate HCN made in the anode. It is just more flexible and beneficial to strip hydrogen from ammonia and methane, enabling more, an arbitrage of products (formamide, methanol, ammonia, urea, hydrogen, and D.I. water) than conventional electrolysis.

The anode produces H⁺ and HCN from CH₄ and NH₃, and the H⁺ flux through the proton conducting membrane may be 90 m³/h/m². This is a representative flux number and may be improved or different with temperature, pressure and new materials. The eARM reactor produces higher conversion to HCN, if it is operated at pressure. It is recommended to operate the proton-conducting ceramic membrane reactor to produce HCN from CH₄ and NH₃ at between 1 to 35 barg.

A hydrogen flux of >11,324 m³/h can be achieved with 780 tubes a meter long of about 124 m² surface area of the membrane.

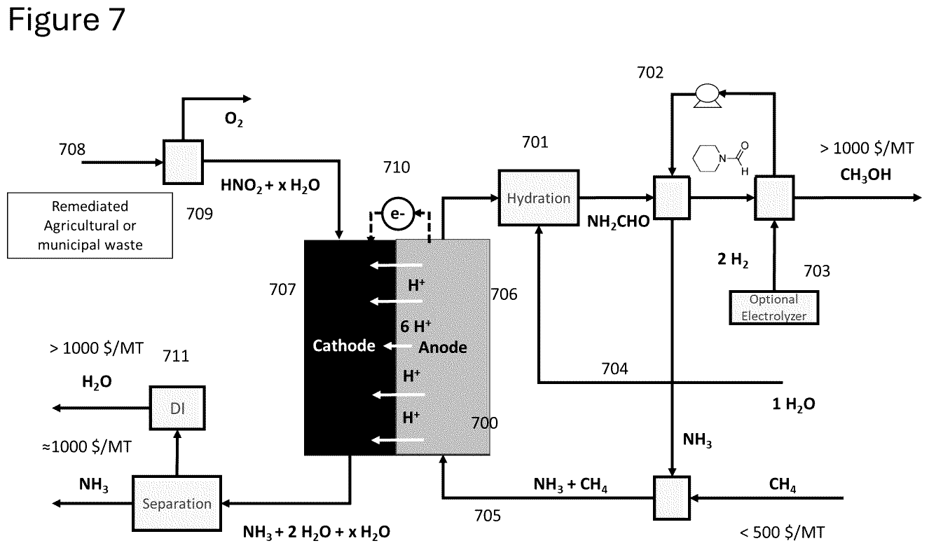

FIG. 7 shows the process flow diagram centered around a ceramic proton-conducting membrane reactor (700) in which the ammoxidation reaction is split between the anode (706) and cathode (707). The anode reacts ammonia and methane to produce protons and HCN. Protons transverse the ceramic proton conducting membrane to react with NOx in the cathode. (If O₂ is used instead of NOx then the process would resemble the process of FIG. 5 using a ceramic proton-conducting membrane fuel cell instead of a SOFC.)

In the ceramic proton-conducting membrane fuel cell the electron flow follows the H⁺ flow direction. The electron flow (current) may generate power (at Unit 710). Ammonia is made on the cathode side of the electrochemical ammonia reforming of methane reactor (700 called eARM). Since in the configuration of FIG. 7 no oxygen mixes with the ammonia and methane, then the unselective side reactions of CO and NO production (concerns in the SOFC) do not happen.

The reaction to hydrogenate NOx to NH₃ on the Cathode side is very facile and may happen at low temperature.

The auxiliary reactions of 701 (hydration), 702 (transamidation), 703 (hydrogenation) are similar to the PFD of FIG. 6 but in the case of the ceramic proton-conducting membrane no water is formed in the anode, so, water formed in the Cathode (707) is fed to the hydration reactor, 701. Power generated by the ceramic proton conducting fuel cell of FIG. 7 may be used to generate hydrogen in an electrolyzer or the eARM process may reduce the amount of NOx in the Cathode such that some protons produce NH₃ and H₂O and some protons recombine to make H₂.

Power is generated the overall electrochemical reactions in the eARM of:

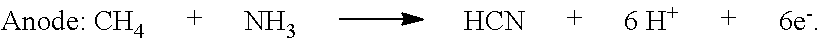

Nickel may be used as a cathode material in the ceramic proton-conducting electrochemical reactor, or LSCoMnO₃ as another example.

FIG. 8 is a process flow diagram showing the production of urea by the dehydrogenative coupling of formamide and ammonia at unit 804. Formamide passes through intermediate isocyanic acid, which reacts with ammonia to make Urea. The process is like the Wöhler reaction. The dehydrogenative coupling reaction may either generate hydrogen (see options at 805) or the generated hydrogen may be oxidized to water, in-order-to improve the reaction conversion. Wöhler-like production of urea is a superior route to ammonia direct carbonylation; this is best achieved by way of the eARM reactor to make formamide. Dehydrogenative-coupling reaction producing urea and H₂O can be brought to 98% conversion.

In similarity to FIG. 7 PFD, Unit 803 is a hydration reaction, in which the HCN made in the eARM reactor (800) is hydrated to formamide. Hydration catalysts also include: Amberlyst 35 at 100 C, Ferrierite at >150 C, Cu and Ca montmorillonites at <200 C, TiO₂>200 C and Fe and/or Cu ZSM-5 at >225 C, Nb/La—TiOₓ at 97% at 250° C., Ni/TiOx at <300° C., Fe/TiOx at <300° C., 90% yield, Nb-ZSM-5 at <250° C., 85% yield and Al₂O₃ 400° C.

That formamide is in part or in full sent to hydrogenation at unit 808 to make methanol and ammonia. Ammonia may also be made in the transamidation reaction at section 807 of the PFD of FIG. 8.

The products of this new process tend towards formamide, or split formamide (NH₃+CO or NH₃+HCOOH in wet conditions, depending on conditions). Excess ammonia may be fed in the eARM reactor (800) as compared with methane, the hydration reactor may direct a 1:1 molar ratio of formamide and ammonia to dehydrogenative coupling at 804 to make Urea and hydrogen.

Methanol is purified to >99.85% purity in a MgCl₂ polishing reactor shown at 809. Other purifying absorbents may be used, including MgCl(OH) [27 mols-NH₃/kg-absorbent], CaCl₂), CaBr₂, Na—Y or all of the above adsorbed on Na—Y.

Formamide itself may be converted to either urea or methanol and ammonia [3 CH₄+H₂O+HNO₂→3 CH₃OH+NH₃]. The current innovation further indicates that formamide may be transamidated or transformylated to another amide, such as formylcarbazole, which is then hydrogenated to methanol and ammonia at helpful low temperature. A great advantage of this innovation is other industrial hydrogenation of CO₂ or CO takes place at temperatures, which limit the thermodynamic equilibrium concentration of methanol, which limits one-pass conversion, which requires extensive recycle, a CAPEX costly process in the CO₂ or CO starting point processes.

Since the new processes utilize energy from both methane and electricity, the new processes require much less electricity to operate than the electrolysis-only-based Haber Bosch process. Therefore, this is a superior method to make green ammonia, since the process is immune to dynamic electricity issues, makes two or three revenue generating products, and causes no net nitrification.

Conspicuously, the new innovations start from nitrate instead of air-scavenged N₂ as the source of nitrogen. Therefore Haber-Bosch processes cause additional nitrification of soil and waterways whereas the current innovation does not cause any new net nitrification of the Earth.

Electrolysis-Haber-Bosch process has several pieces of equipment reliant on electrical input, including high-pressure feed compressors (up to 16% of the total electrical needs), a PSA compressor or vacuum, a 90 Bar H₂ recycle compressor, water electrolysis, and probably and electrically driven chiller. These unit operations of the competitive process cause a high dependence on the 24/7 steady feed of electricity. Whereas the processes of FIGS. 6, 7, and 8, only has optional electrolysis. The eARM generates power or hydrogen; therefore, the present innovation is much less vulnerable to feed electricity dynamics as compared with electrolysis-driven Haber-Bosch ammonia. The processes shown in FIGS. 6, 7 and 8 are autothermal (generate their own needed heat); do not require high-pressure gas compressors; and have high conversion reactors.

The new process (PFD in FIG. 7) may also produce D.I. water, another valuable product. The eARM reactor may feed just enough NOx to produce hydrogen for the splitting of formamide to methanol and ammonia. In which case no electrolyzers are needed. In FIG. 7 at Unit 711 the water derived from the HNO₂ hydrogenation may be sold as D.I. water after cleanup in Unit 711. In order for D.I. water to be a product, some formamide or urea would also be a coproduct as shown in the overall balance:

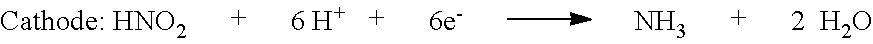

(in accordance with FIG. 8)

FIG. 8 is a process flow diagram showing the reaction of ammonia and methane at the anode of a proton-conducting membrane reactor. The anode reaction produces HCN and protons move across the proton-conducting membrane to react with NOx in the cathode. When NO is used as an oxidant in the cathode then the reaction is proton rich, meaning less or no water electrolysis (see Equation 11 of Table 1).

When O₂ is used in majority with NOx on the cathode side, then the process may still produce methanol from methane and make small amounts of ammonia, which is internally recycled to make up for the consumed NH₃ by reaction inefficiency (trace loss to N₂).

The Ceramic membrane reactor represented by Anode 801 and Cathode 802 is fuel cell. It has a net production of power since the reaction to make HCN from methane and ammonia and the production of water from NOx and H₂ are net Gibbs Energy favorable.

The hydrogenation of formamide to methanol and ammonia (808 of FIG. 8) is a thermodynamically favorable method to make Methanol (see Table 2).

Several types of proton-conducting membrane materials suitable for the reactor (Cathode 802 or 707 and Anode 801 or 706). The proton electrochemical ceramic membrane reactor of this work does not require (although is present on the cathode side) the addition of any steam or oxygen, allowing a variety of ceramic materials precluded from solid oxide electrolysis to be used for the anode and ceramic electrolyte, including but not limited to, doped-CaZrO₃ and CaZr(In)O₃ perovskites. The materials used in the main (eARM) electrochemical ceramic membrane reactor may be based on ceramic oxides or composites (ceramic/metal composites (cermets)) thereof.

Materials useful for the ceramic proton-conducting electrochemical reactor, cerate and zirconate perovskite have proton conductivity in hydrogen-rich atmospheres, particularly when they are doped with a rare earth ions. BaCeO₃ and SrCeO₃ type materials with the perovskite structure in the presence of hydrogen have proton conductivity. BaCeO₃ and SrCeO₃ may be doped with Y, Yb, or Gd to periodically replace Ce in the lattice.

Proton transport materials and their H⁺ transport temperature ranges that will perform in eARM reactor include, those listed in Table 4:

TABLE 4

| Sr-doped LaPO₄ | 500 to 925 | C. |
|---|---|---|
| Sr-doped La₃O₃O₉ | 700° | C. |
| BaCe_{0.9}Y_{0.1}O_{3-α} (BCY) | 500-900° | C. |
| BaZr_{0.9}Y_{0.1}O_{3-α} (BZY) | | |
| Ba₃Ca_{1.18}Nb_{1.82}O_{8.73}(BCN18) | 600 | C. |
| (La_{1.95}Ca_{0.05}) Zr₂O_{7-δ} | 500-900 | C. |
| La₂Ce₂O₇, Eu₂Zr₂O₇ | 800 | C. |

Acceptor-doped BaCeO3
H₂S/(B₂S₃ or Ga₂S₃)/(GeS₂, SiS₂, As₂S₃ or CsI)
Doped-CaZrO₃ and CaZr(In)O₃

Cerates, which are unstable in the presence of CO₂ [Nature Energy, doi:10.1038/s41560-017-0029-4 (2017)] may be used in the present system, since the NH₃/CH₄ reactor does not contain any oxygenated molecules.

In the main form of the innovation, it uses a ceramic proton-conducting membrane reactor to react ammonia and methane and oxidize the generated protons with O₂ or NOx or both or a deficit of oxidant to retain some H₂.

HNO₂ and NO are obtained from reclaimed nitrate in natural settings, such as anaerobic biodigestors, Ag waste, cow and chicken manure, municipal waste, and unconsumed fish farm feed. By reclaiming nitrate from the environment this process makes no net nitrification of the environment and no CO₂ emission, a true circular economy approach.

HNO₃ or NaNO₃ may be purchased or obtained from the environment or biodigestors and converted to and separated from gas-phase HNO₂ (HNO₃→0.33 H₂O+0.33 HNO₂+0.66 NO+0.66 O₂). NaNO₃ may be converted to HNO₂, 0.5 O₂ and NaOH.

Green nitric acid will be produced by some companies in the near future.

Nitrates are available from the waste of the adipic acid process.

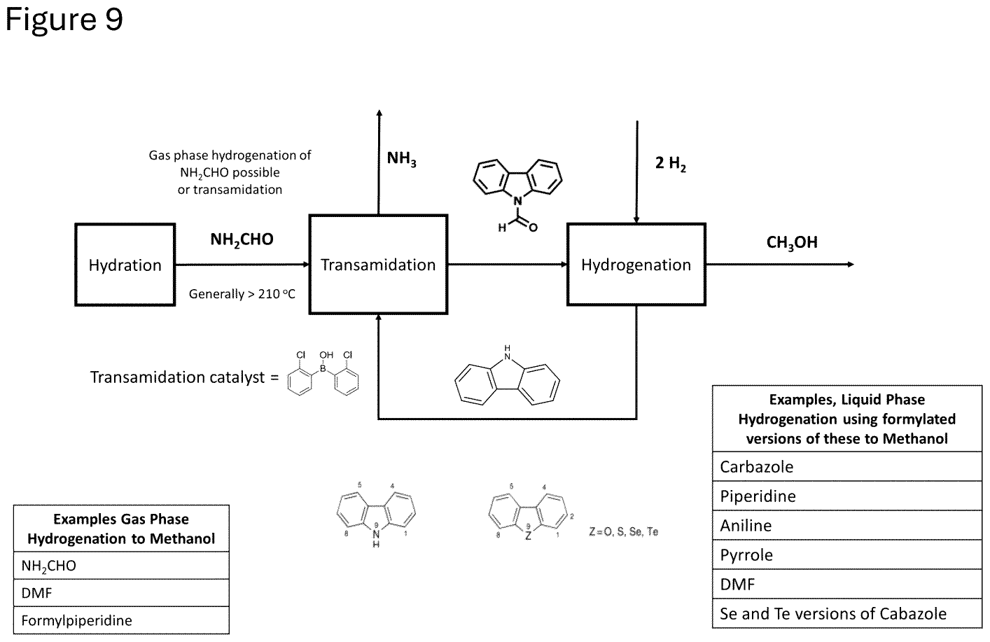

FIG. 9 shows a detail of the process flow diagram to hydrate, transamidate and hydrogenate. Formamide is reacted with another amine, such as Carbazole, shown in FIG. 9 to make the formyl version of Carbazole and release ammonia. The new amide (N-formylazole) is hydrogenated to split off methanol and remake Carbazole. Carbazole is just an illustrative example, and any amine that will undergo transamidation with formamide to release ammonia in high yield is usable, while it must have the simultaneous property to be hydrogenated to methanol in high yield with the recycling of the starting amine (in the case of the example of FIG. 9, Carbazole).

A general transamidation formular is shown as:

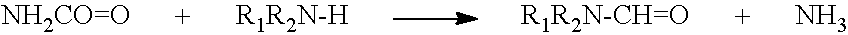

Where R═CH₃, cyclic, aromatic, heteratom and Benzyl amine is particularly effective using B(OH)₃ catalyst. Thanh Binh Nguyen [Organic Letters, Vol. 14, No. 12 3202-3205] found in 2012 that 10% B(OH)3 between 25 to 150° C. catalyzed the exchange of formamide (HCONH₂) with R₁R₂N—H to R₁R₂N—CH═O and ammonia when R=primary amines, secondary amines, and anilines. Benzylamine was found to react at room temperature. Primary alkyl amines and anilines required higher temperatures (100-150° C.). The reaction of formamide (NH₂CH═O) at 25 C with Benzylamine obtains 97% yield to ammonia and the new amide.

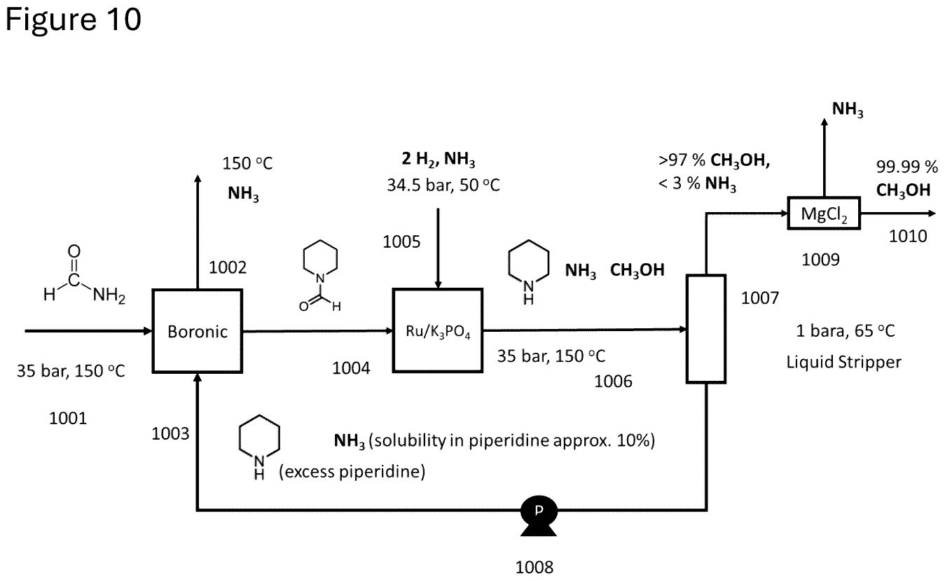

FIG. 10 indicates pressures and temperatures of interest for the process to transamidate formamide and hydrogenate the transamide. The example of piperidine is provided as the amine used to transamidate formamide. As indicated above, other amines can be used, such as benzylamine. Many electrolyzers can be operated at 30 to 35 bar. The pressure of the transamidation section of the process is operated around 30 bar in anticipation of the electrolyzer outlet pressure where hydrogen at 1005 is inlet to the hydrogenation reactor 1004. Ammonia is separated from the formylpiperidine in reactor 1002. The large difference in molecular weight between ammonia and formylpiperidine assists in the separation process. Boronic acid may be used as a transamidation catalyst.

Hydrogenation catalysts in addition to shown (Ru and K₃PO₄) in FIG. 10 include nickel, platinum, molybdenum, supported Pd, Au, Ag, Fe, homogeneous and heterogenous catalysts, bimetallics including Mo—Fe, Fe—Pt, Ni—Cu—Pd, Cu/ZnO/Al₂O₃ Homogeneous iron carbonyl with co-catalysts triazabicyclodecene provides good kinetics at 30 bar and 100° C. with 86% conversion to methanol, when the ligands are modified on the iron carbonyl, including BH₃, ligand.

Outlet from hydrogenation reactor 1004 is piperidine, methanol and small amounts of ammonia which may be soluble in formylpiperidine. Methanol is separated from piperidine and ammonia in a striping column, since methanol is lower boiling and ammonia is soluble in piperidine (or benzylamine or other amines as described above). The temperatures of these reactions are kept below 150° C., providing good thermodynamic equilibrium production of methanol. Benzylamine boils at 185 C and piperidine boils at 106° ° C. at 1 atmosphere. The reactions full process may take place in the liquid phase if preferred, since at pressure the amides and amines are liquids in the 110 to 185° C. range.

The process shown in FIGS. 6, 7, 8 and details in FIGS. 9 and 10 has many advantages over other dual green methanol-ammonia processes, for example:
a. eSMR to methanol is steam reforming with electricity for heat, it is energy intensive.
b. dual ammonia-methanol processes are less flexible in ratio of products;
c. industrial dual processes are usually operated at >200 bar to produce NH₃ and approximately 100 bar to produce CH₃OH, energy intensive and downtime risk;
d. all other ammonia processes require air separation units (cryogenic or PSA)
e. Natural gas steam reforming-based methanol production requires water feed;
f. Electrolysis based ammonia and methanol production are impractical when dependent on dynamic solar and wind;
g. electrolysis-based CO₂ to methanol, if not grid-connected requires wind and solar overbuild meaning expensive CAPEX.

It is beneficial and innovative to reform methane through formamide (H₂N—C(═O)(H)) instead of O═C═O, C═O, H₂.

The carbon of formamide has a more reduced oxidation state (formally +2) as compared to carbon dioxide (formally +4). The reduction of highly oxidized carbon always has inefficiency energy associated; methanol, the product that we are reducing to has carbon in a formal oxidation state of −2. Formamide is a chemical surrogate for isocyanate, which is part of the Wöhler mechanism to urea.

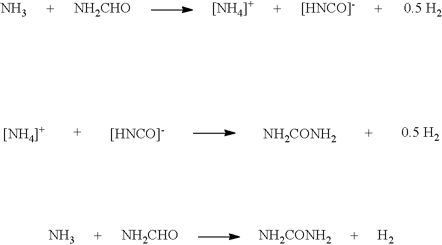

Formamide resonance structures indicate a partial negative charge on the carbonyl oxygen, making it accessible during hydrogenation to form an alcohol precursor to methanol.

In contrast, carbon dioxide, which other investigators use as a starting point is a very stable compound, requires higher temperature and pressure to hydrogenate in the gas phase, requires more electrolysis power to produce 3 H₂ (Equation 12 of Table 1) instead of 0 (Equation 11 of Table 1) to 2 H₂ and has low yields by thermodynamics and experimental results. For example, thermodynamic equilibrium calculations indicate 15.75% yield to methanol starting from 10/1=H₂/CO₂ at 350° C. and 100 bar [Chem. Rev. 2017, 117, 9804-9838].

Carbon monoxide is the starting material of the commercial process. Typically that CO is derived from the reforming of methane which most often indicates water input. Carbon monoxide hydrogenation in the commercial processes has low conversion (10 to 35%), high recycle (3 to 8 ×), high cooling duty, large distillation columns, compressors operating up to 100 Bar and recycle compressors. Carbon monoxide becomes more stable at high temperature in comparison to most other molecules, so increasing temperature does not necessarily help. It requires a minimum of 2 H₂ per methanol produced (Equation 13 of Table 1).

The CO based commercial reactor to methanol is a 4 multibed reactor with side feeds, high and low-pressure methanol separators, air cooling and purging of methanol and other carbon products (used as fuel with eventual CO₂ emissions), two separate distillation columns (a very tall distillation column is required to separate water from methanol) and up to 8 to 1 recycle. [AMPCO]. The innovative process herein avoids all these issues (no high pressure, no extensive recycle, no water-methanol distillation, no CO₂ emissions and no water input).

Table 5 and 6 show reactions that may take place in the process flow of FIG. 8. The process of FIG. 8 offers a product arbitrage, meaning one can produce different ratios of Urea+methanol+H₂O (Equation 16 of Table 6) or Urea+H₂, or Formamide+H₂ or Formamide+H₂O (HNO₂+CH₄→NH₂CH=O+H₂O (D.I.)) or methanol or methanol+ammonia (Equation 15 of Table 5). The product arbitrage enables a so called “future-proof” process which can be adjusted to a product mix depending on the future federal incentives and internal market prices.

TABLE 5
Ammonia + Methanol Net Reactions

Eq

| | Cathode | HNO₂ + 3 H₂ --> NH3 + 2 H₂O |
|---|---|---|
| | Anode + Hydration | CH₄ + NH₃ + H₂O --> 3 H₂ + NH₂CHO |
| | Formamide | 2 H₂ + NH₂CHO --> NH₃ + CH₃OH |
| | Hydrogenation | |
| | Electrolysis | 2 H₂O -->2 H₂ + O₂ |
| 15 | Net | HNO₂ + CH₄ + H₂O → NH₃ + CH₃OH + O₂ |

TABLE 6
Urea + Methanol + H₂O Product Reaction Steps

Eq

| | | |
|---|---|---|
| | Cathode | 2 HNO₂ + 6 H₂ --> 2 NH₃ + 4 H₂O |
| | Anode | 2 CH₄ +2 NH₃ + 2 H₂O --> 6 H₂ + 2 NH₂CHO |
| | Urea (if H₂O | 2 H₂ + O₂ + 2 NH₂CHO --> (NH₂)₂CO + |
| | need) | H₂O + CH₃OH + 0.5 O₂ |
| | Urea (if H₂ | NH₃ + NH₂CHO --> (NH₂)₂CO + H₂ |
| | desired) | H₂ + H₂ + NH₂CHO --> NH₃ + CH₃OH |
| | Electrolysis | H₂O --> H₂ + 0.5 O₂ |
| 16 | Net | 2 HNO₂ + 2 CH₄ → (NH₂)₂CO + CH₃OH + |
| | | 0.5 O₂ + H₂O |
| | Net on common | HNO₂ + CH₄ → 0.5 (NH₂)₂CO + 0.5 CH₃OH + |
| | methane feed | 0.25 O₂ + 0.5 H₂O |

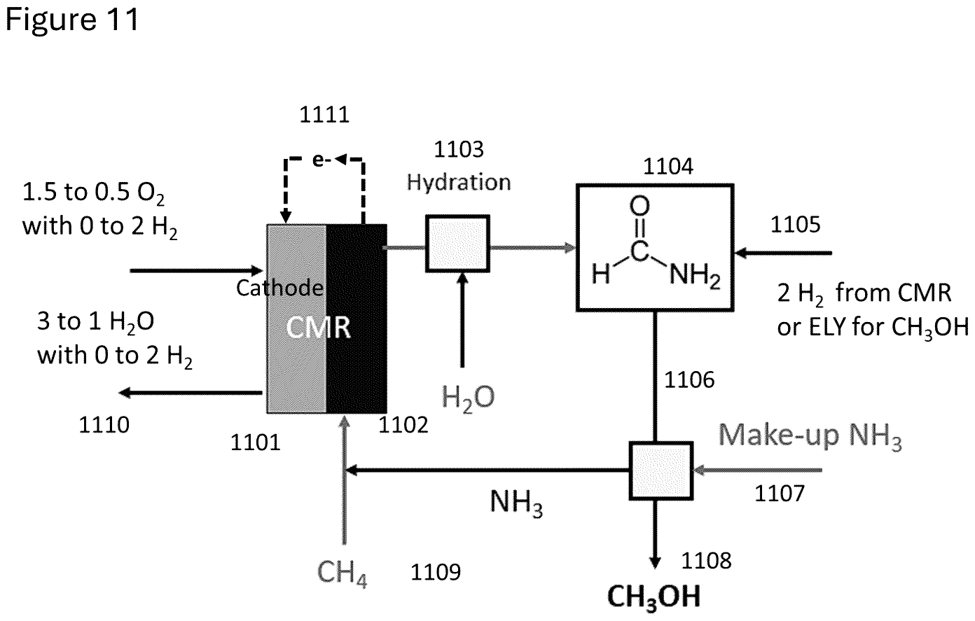

FIG. 11 indicates the process flow diagram using a proton-conducting ceramic membrane reactor (CMR) fuel cell (Unit 1101) to produce methanol (outlet 1108). Trace ammonia is lost as N₂ in the anode 1102; so, some makeup 1107 ammonia is added to the process.

Three to one moles of water may be produced (outlet 1110) in the cathode. One mol of water is used in the hydration reactor (Unit 1103) and 2 moles of a water may be electrolyzed to hydrogen (1105 ELY). To operate the hydrogenation of formamide reactor (11104) hydrogen may be directly derived from the CMR Cathode (shown at 1110 in option “1 H₂O and 2 H₂”). No net water is theoretically needed for the process shown in FIG. 11. The process of FIG. 11 produces methanol and water balanced.

The processes of FIG. 5, 6, 7, 8 may produce formamide or urea, which enables a co-product of net D.I. Water.

The CMR is a fuel cell that generates electric power. The CMR in eARM mode, meaning a proton conducting membrane, is de facto an electrolyzer of CH4+NH3, however approximately one mole of produced H₂ may be oxidized to H₂O on the cathode side to make the eARM ΔG favorable (See Table 3).

The electric power generation of the CMR (shown at 1111) and the heat of the CMR and hydration reactor exotherm converted to additional power makes the process of FIG. 11 nearly electrical power net zero.

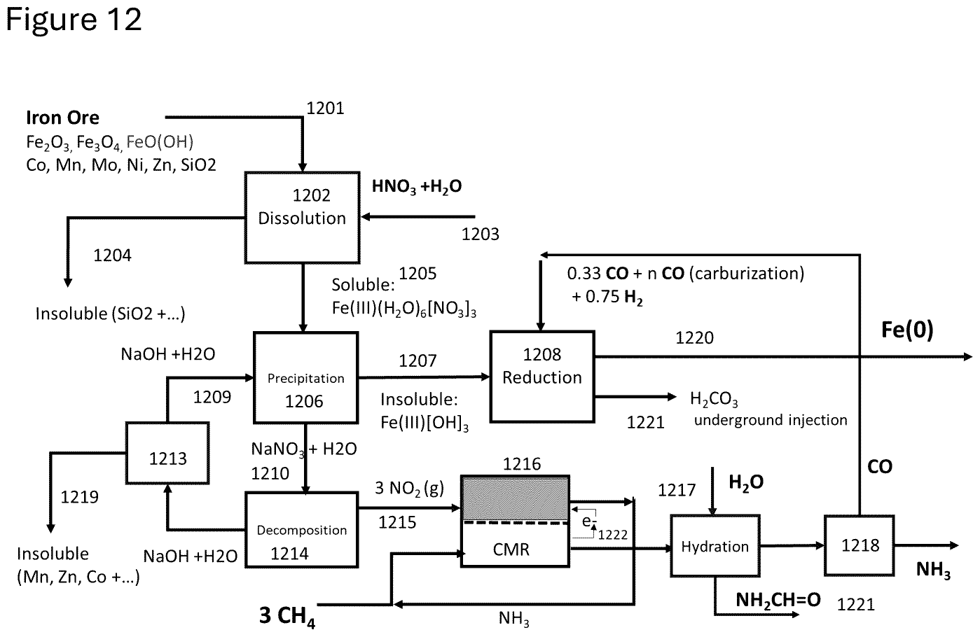

FIG. 12 is a process flow diagram that uses nitric acid to dissolve iron ore. The process of FIG. 12 reduces the iron ore with the resulting carbon monoxide and hydrogen generated by the CMR process (CMR process similar to FIG. 8), see 1208 and 1218. FIG. 8 at 805, the dehydrogenative coupling of ammonia and isocyanic acid generated urea and hydrogen. At Unit 803, the hydration of HCN produces formamide. Formamide can be split into ammonia and carbon monoxide as shown in FIG. 12, unit 1218. Prior to hydrogenation of formamide, the application of heat and lowered pressure and a catalyst (natural zeolite is an example catalyst), enables the splitting of formamide to ammonia and CO. The CO generated at Unit 1218 is sent for reducing Fe(III)(OH)₃ (and trace Fe(III)(H₂O)₆(NO₃)₃) at unit 1208.

The process flow diagram of FIG. 12 indicates that low quality iron ore may be a process input. The process enables the processing of ore at the mine to save on shipping costs, greatly lowering steel production cost.

Whereas other processes would want to avoid nitric acid since it can generate waste, the current process uses nitric acid to generate Fe(III)(H₂O)₆(NO₃)₃ and similar iron species, since downstream, the nitrates will be converted to ammonia in our eARM fuel cell shown at 1216.

Table 7 shows the reactions of interest associated with the process of FIG. 12. After Fe(III)(H₂O)₆(NO₃)₃ is generated NaOH is used to convert Fe(III)(H₂O)₆(NO₃)₃ to Fe(III)(OH)₃ in Unit 1206.

NaNO₃ that is generated together with Fe(III)(OH)₃ is separated out, by precipitation of Fe(III)(OH)₃, in Unit 1206 then in 1214, NaNO₃ is converted to NO₂ and NaOH.

The NO₂ produced in 1214 is sent to the CMR reactor where it is converted to NH₃ and recycled to the anode of the CMR reactor.

Fresh CH₄ (from biomass, RNG, gas deposits) is reacted in the anode of the CMR with ammonia to generate HCN and protons. The protons transverse the proton conducting membrane reactor to react with the NO₂ in the cathode to make ammonia and electrical current (1222).

The process generates electrical power (indicated on the CMR at 1222) and HCN that is hydrated to formamide in Unit 1217. Some formamide is sent to produce urea and some formamide is sent to reactor 1218 where it is split into CO and NH₃. The generated formamide partially fed to a urea reactor using the Wohler-like process and partially split into ammonia and carbon monoxide in Unit 1218 by the application of heat, the lowering of pressure and a low-cost acid or base catalyst.

The Unit 2018 generated CO is sent to Unit 1208 to reduce Fe(III)(OH)₃ to Fe(0). In the process of making Fe(0) some H₂CO₃ is generated. To make CO₂-free steel, said H₂CO₃ must be injected underground or used.

The generated ammonia at Unit 1218 may be reacted with NH₂CH═O from hydration reactor 1217 to produce some Urea and some hydrogen. The process flow diagram of FIG. 8 at Unit 804 and 805 show the process to make Urea and hydrogen using dehydrogenative coupling of formamide and ammonia. Hydrogen is generated and may be sent to unit 1208 to further reduce Fe(III)(OH)₃ to Fe(0).

The process of FIG. 12 co-produces urea with Fe(0) starting from low quality ore. The renewable energy footprint for the process is very low (little external electricity needed), enabling the conversion of iron ore at the mine (where there is often little space or motivation to build a renewable energy park).

The process has a small footprint since little to know renewable power generators (no solar panels, no wind turbines, no CSP) are needed since the eARM reactor generates electricity at Unit 1216 at 1222. The overall process with pumps and heat generation does need electric power, but considerably less than iron ore electrowinning processes, considerably less power is needed, by nearly 100× reduction compared with melting and electrically reducing iron ore.

TABLE 7

| | | |
|---|---|---|
| 0.5 (Fe₂O₃ and Fe₃O₄) + 3 HNO₃ + H₂O→ Fe(III)(H₂O)₆[NO₃]₃ | Green Nitric, Low-Quality | Eq. 17 |
| | Ore, Separation | |
| Fe(III)(H₂O)₆[NO₃]₃ + 3 NaOH → Fe(III) [OH]₃ +3 NaNO₃ | Precipitates | Eq. 18 |
| Fe(III)[OH]₃ + 1.5 CO → Fe(0) + 1.5 H₂CO₃ | Low quality ore on- | Eq. 19 |
| | location to Fe(0) | |
| 0.33 Fe(III) + [OH—] + 0.5 H₂ →0.33 Fe (0) + H₂O | Syngas reduction of Fe(III) | Eq. 20 |
| 0.66 Fe(III) + 2 [OH—] + CO → 0.66 Fe (0) + H₂CO₃ | using hydrogen generated | |
| | from Urea production | Eq. 21 |
| NH₃ + NH₂CHO --> (NH₂)₂CO + H₂ | Dehydrogenative | Eq. 22 |
| | coupling, generate Urea. | |
| 3 NaNO₃ → 3NaOH + 3 NO₂ | NaOH is recycled | Eq. 23 |
| 1.5 H₂ + 3 NO₂ + 3 CH₄ + 3 H2O → 3 NH₃ + 3 CO + 6 H₂O | Some CO is recycled, NH₃ | Eq. 24 |
| | production | |
| 1.5 CO + 3 NH₃ → 1.5 (NH₂)₂CO + 1.5 H₂ | Either Urea or 2/1 | Eq. 25 |
| | Ammonia/Methanol | |

Finally, one may simply produce green ammonia or ammonium nitrate by direct hydrogenation of remediated nitrogen oxides as a method onsite to cleanup water nitrification and make valuable products.

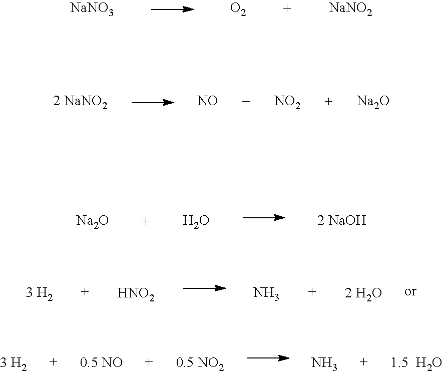

The methods, materials, processes and apparatuses shown in this document instruct an arbitrage of various products including the way to make green ammonia coproduced with green methanol without net nitrification of soil and waterways, without CO₂ emission/production, without precious water input (if formamide or urea product), and minimal renewable energy footprint; thus enabling beneficial sustainable fertilizers, fuels and chemicals.

What is claimed is:

1. A method to split water into H₂ and O₂
Wherein, Water is added to a surrogate carrier molecule by catalytic hydration;
The hydrated surrogate is dehydrogenated to release H₂ with or without electrical input;
The HER may occur in series and non-simultaneously to the OER reaction;
The dehydrogenated surrogate molecule is either sold, stored for later processing or deoxygenated to produce the starting surrogate molecule and release O₂.

2. The method of claim 1 in which the hydrated surrogate carrier molecule is an amide, preferably formamide, H₂NCH═O.

3. The method of claim 1 wherein the HER is a non-simultaneous HER reaction in which hydrogen is extricated from the hydrated surrogate molecule with little to no electrical input.

4. The method of claim 3 wherein the extrication of H₂ from said hydrated surrogate molecule by a catalytic reaction that is ΔG negative and the combined hydration plus dehydrogenation reaction are exothermic.

5. The method of claim 1 wherein, in the OER reaction, O₂ is removed from the dehydrogenated surrogate molecule in a solid oxide membrane reactor.

6. The method of claim 5 wherein, in the OER reaction, isocyanic acid is converted to HCN and O₂ is expelled in the Cathode of an SOEC.

7. A method to produce methanol from methane
Wherein, methane is reacted with ammonia to produce hydrogen or protons and HCN;
Said H₂ or protons are partially or totally oxidized to water and H₂ using an electrochemical ceramic membrane reactor;
Said oxidation may take place in said ceramic membrane reactor in the cathode of a ceramic proton conducting membrane reactor or the anode of a solid oxide fuel cell The produced HCN is hydrated to formamide;
Formamide may be transamidated to a new amide and release ammonia;
Formamide or the transamide may be hydrogenated to methanol;
A portion of the formamide may be dehydrogenatively coupled with ammonia to produce urea and hydrogen;
Formamide and water may be an alternative product.

8. The method of claim 7 in which protons transverse a proton-conducting ceramic membrane reactor to react with a portion of O₂ or NOx at the cathode and said portion of O₂ or NOx may convert all the protons transversing the ceramic membrane or only some of the protons such that the remaining protons are converted to H₂.

9. The method of claim 8 wherein said production of HCN from ammonia and methane in which the proton conducting membrane of is operated at between 1 to 35 barg and T=400 to 1100° C.

10. The method of claim 8 wherein an oxidant NOx that is composed of HNO₂ or NO or a mixture of HNO₂ and NO in exact stoichiometric proportion to convert all the protons transversing said membrane or a fraction of said protons, such that some protons are converted to H₂.

11. The method of claim 10 wherein a reaction of said NOx and protons to produce ammonia and water.

12. The method of claim 8 wherein the proton-conducting ceramic membrane is composed of one of the following materials: cerate and zirconate perovskite doped with a rare earth ions, BaCeO₃ and SrCeO₃ type materials with the perovskite structure, BaCeO₃ and SrCeO₃ may be doped with Y, Yb, or Gd to periodically replace Ce in the lattice, Sr-doped LaPO4, BaCe_{0.9}Y_{0.1}O_{3-α} (BCY), (La_{1.95}Ca_{0.05}) Zr₂O_{7-δ}, La₂Ce₂O₇, Eu₂Zr₂O₇, Doped-CaZrO₃ and CaZr(In)O₃.

13. The method of claim 7 wherein the HCN hydration reaction is catalyzed by Nb/La-TiOx, Fe/TiOx, Ni/TiOx, TiO₂, Amberlyst 35 at 100 C, Ferrierite at >150 C, Cu and Ca montmorillonites at <200 C, TiO₂>200 C and Fe and/or Cu ZSM-5 at >225 C, Nb-ZSM-5, Al₂O₃ at 400° C.

14. The method of claim 7 wherein the transamidation is catalyzed by Boronic Acid, R—B(OH)₂, Boric Acid, B(OH)₃ and derivatives, including, dichlorophenylboronic.

15. The method of claim 7 wherein the hydrogenation reaction is catalyzed by Ru/K3PO4 or Nickel or platinum or Ru bimetallics or other transition metals supported on solid acid supports, including Al₂O₃ and SiO₂.

16. A method to produce reduced state iron (Fe(0)) starting from iron ore containing Fe₂O₃ and Fe₃O₄ and nitric acid:
Wherein, said Fe(III) in ore is converted to Fe(III)(H₂O)₆[NO₃]₃;
Fe(III)(H₂O)₆[NO₃]₃ is converted to Fe(III)[OH]₃;
Fe(III)[OH]₃ is reduced with CO and optionally H₂ to reduced iron, Fe(0);
Said nitric acid is converted to NaNO₃;
Said NaNO₃ is converted to NaOH and NO₂;
Said NO₂ in converted in a proton-conducting ceramic membrane reactor to NH₃ in a cathode, while the anode converts Methane and NH₃ to HCN and protons which are sent to the cathode;
Said produced HCN is hydrated to Formamide and a portion of said formamide is sent to urea reactor whereas a second portion of the formamide is split into CO and NH₃;
Said CO is used to reduce Fe(III)[OH]₃ to Fe(0);
H₂CO₃ produced by the reduction of Fe(III)[OH]₃ to Fe(0) may be injected underground Said produced formamide and NH₃ is converted to urea and H₂ in a Wohler-type process Optionally produced H₂ is sent the Fe(III)[OH]₃ reduction reactor to make Fe(0) producing water.

17. The method of claim 16 wherein the proton-conducting ceramic membrane is composed of one of the following materials: cerate and zirconate perovskite doped with a rare earth ions, BaCeO₃ and SrCeO₃ type materials with the perovskite structure, BaCeO₃ and SrCeO₃ may be doped with Y, Yb, or Gd to periodically replace Ce in the lattice, Sr-doped LaPO4, BaCe_{0.9}Y_{0.1}O_{3-α} (BCY), (La_{1.95}Ca_{0.05}) Zr₂O_{7-δ}, La₂Ce₂O₇, Eu₂Zr₂O₇, Doped-CaZrO₃ and CaZr(In)O₃.
